(19) United States
(12) Patent Application Publication
(10) Pub. No.: US 2023/0392858 A1
(43) Pub. Date: Dec. 7, 2023

(54) HOUSEHOLD APPLIANCE AND METHOD FOR OPERATING THE SAME

(71) Applicant: BSH Hausgeräte GmbH, München (DE)

(72) Inventors: Daniel Bihr, Kirchheim am Ries (DE); Stephan Kempfle, Ellzee (DE); Christopher Rodney, Villenbach (DE); Joachim Schäferling, Bissingen (DE)

(21) Appl. No.: 18/249,574

(22) PCT Filed: Oct. 6, 2021
(86) PCT No.: PCT/EP2021/077526

§ 371 Date: Apr. 19, 2023

(30) Foreign Application Priority Data
Oct. 19, 2020 (DE) 10 2020 213 159.7

(51) Int. Cl. F25D 29/00; H04N 7/18; H04N 7/10

(52) U.S. Cl. CPC F25D 29/00; H04N 7/183; H04N 7/108; F25D 2400/36; F25D 2400/40

(57) ABSTRACT

A household appliance has a sensor module and a control unit which are connected to one another via a cable harness containing a cable to supply power to the sensor module and to transmit data. The sensor module is connected to the control unit via an FDP-link III-compatible or GMSL-compatible connection which contains a serializer which is associated with the sensor module, a deserializer, and a cable harness which connects the serializer and the deserializer. A method is used to operate the household appliance, in which, sensor data generated by the sensor module are translated into FPD-link III-compatible serial data by the serializer of the FPD-link III connection. The serial data are transmitted via the cable harness to a deserializer and are back-translated therein, and the back-translated sensor data are transmitted to the control unit. The method is used in refrigeration appliances having cameras for recording images.

The invention relates to a household appliance that has at least one sensor module and a control unit, which are connected to one another so as to supply power to the sensor module and to transmit data by a cable set that comprises at least one cable. The invention also relates to a method for operating a household appliance that has at least one sensor module and a control unit, which are connected to one another so as to supply power to the sensor module and to transmit data by a cable set that comprises at least one cable. In particular, the invention is advantageously applicable to refrigeration appliances, especially those having multiple cameras for capturing images of a refrigeration chamber.

The requirements for digital functionalities of household refrigeration appliances are increasing, and the refrigeration appliances are also becoming increasingly larger. Often, the number of cameras used in the refrigeration appliances is increasing, and they have to be connected over ever longer distances to the control units that drive them.

In previous camera systems, USB is usually used for communication between the control units and the cameras. In so doing, the camera can have its own control unit or it can be controlled centrally. In another known camera system, the cameras are connected to the control unit via an LVDS interface. In both cases, a shielded USB cable having at least four cores is used so as to supply power and to transmit data. This means that there are always at least four cores per camera that have to be routed through the device.

DE 10 2013 211 098 A1 discloses a refrigeration appliance that comprises a camera module for capturing image data of a refrigerated product in a refrigeration chamber of the refrigeration appliance, a processing facility for processing the image data, and a data bus for transmitting the image data from the camera module to the processing facility.

The object of the present invention is to at least partially overcome the disadvantages of the prior art and, in particular, to use a simple and reliable sensor architecture or a simple sensor system, which especially allows a cost-effective extension and enables high data volumes.

This object is achieved according to the features of the independent claims. Preferred embodiments are apparent in the dependent claims in particular.

The object is achieved by a household appliance having at least one sensor module and a control unit, which are connected to one another so as to supply power to the sensor module and to transmit data with the sensor module by a cable set that comprises at least one two-core cable, wherein the at least one sensor module is connected to the control unit via a respective FPD-Link III- or

GMSL-compatible or -compliant connection which comprises a serializer that is associated with the sensor module, a deserializer that is associated with the control unit, and a respective cable set that connects the serializer and the deserializer.

By providing an FPD-Link (“(Flat Panel Display-Link”) III- or GMSL-compliant electrical connection between the sensor module and the control unit, this household device results in the advantage that the exchanged data can be transported over long distances by means of a simple and inexpensive cable set in case of a high data volume. This means that transmission distances of multiple meters can be implemented without any problems, which is in contrast to classic ribbon cables, which rarely allow cable lengths of more than 30 cm. As a result, the sensor modules can be arranged and easily connected at practically any point, even in the case of large household appliances.

An FPD-Link III-compliant connection is understood to mean in particular a connection (“FPD-Link III connection”) that is designed in accordance with the FPD-Link III specification or a connection that is downwardly compatible with the FPD-Link III standard. This connection or interface enables the transport of high-resolution digital video data as well as a bidirectional control channel via a cost-effective cable and over connection distances of up to 15 meters or even longer connection distances depending on the requirements.

Alternatively, for the purposes of the present inventors, a GMSL-compliant connection is understood to mean in particular a connection (“Gigabit Multimedia Serial Link”) that is designed in accordance with the GMSL specification. The GMSL-compliant connection also enables the transport of high-resolution digital video data with high bandwidths in complex interconnections via a cost-effective cable and connection distances of up to 15 meters or even longer connection distances depending on the requirements.

Three components are used to transmit signals via FPD-Link III or GMSL: the serializer, which translates the data signals from their original format to FPD-Link III or GMSL, a deserializer, which translates from FPD-Link III or GMSL back to the original format (“Ser-Des”), and the cable set that connects the serializer and deserializer. The FPD-Link III- or GMSL-compliant connection thus behaves completely transparently to data routed over it (sensor data, control commands, etc.).

A further advantage of the FPD-Link III- or GMSL-compliant connection is that it is easy to use sensor modules with different resolutions and speeds, since the serializer is able to work with serializers of different speeds.

It is one embodiment that the serializer of an FPD-Link III- or GMSL-compliant connection is integrated into the respective sensor module and the deserializer is integrated into the control unit. This has the advantage that the sensor module and the control unit can be connected to one another via a simple and inexpensive cable set, which in particular does not require its own electronics.

It is one development that the serializer and the deserializer are integrated into one cable together with the cable set. This has the advantage that the sensor module and the control unit can be designed in a particularly simple and cost-effective manner.

It is one embodiment that the cable set comprises a single coaxial cable for the data and power supply. Such a cable set is advantageously thin, flexible and inexpensive and particularly easy to install.

It is one embodiment that the cable set comprises a (shielded or unshielded) twisted pair cable so as to transmit data (for example sensor data, synchronization data, control commands, etc.) and at least one further cable so as to supply power to the sensor module. Such a cable set can be particularly inexpensive.

It is one embodiment that the cable set is guided into a door of the household appliance via a hinge. The hinge can be a single-joint or a multi-joint hinge. Preferably, the door is pivotable along a vertical axis on the household appliance. Further, the door can be provided as a “French door” having a first and a second door which have opposite opening directions, wherein the first and second door are each connected via a hinge to the household appliance and are each pivotable about a vertical axis in opposite directions away from the body. The cable set can be at least partially accommodated in a cable chain. The cable chain can include multiple links that are connected to one another in pairs and are pivotable relative to one another about axes that are parallel to one another between a stretched stop configuration and a curved stop configuration. When the door is in the open position, the cable chain tends to be in an elongated configuration and when the door is in the closed position, the cable chain tends to be in a curved or looped configuration. Preferably, the cable chain is supported on an upper surface of the hinge, but can also be routed along below and laterally adjacent to the hinge. Due to the thin design of the cable set, it can be guided via a hinge into the door of the refrigerator by simple and cost-effective means, such as in a cable chain, for instance.

It is one embodiment that the cable set is guided into a door of the household appliance via a telescopic rail. The door is preferably a drawer door that is guided for linear movement via telescopic rails. The cable set can be arranged in the telescopic rail, or can be accommodated or guided on the telescopic rail in a cable housing that is suspended from the telescopic rail. Further, the cable set can be at least partially accommodated in a cable chain. The cable chain can include multiple links that are connected to one another in pairs and are pivotable relative to one another about axes that are parallel to one another between a stretched stop configuration and a curved stop configuration. The cable chain is preferably routed below the telescopic rail, but can also be routed along above and laterally adjacent to the telescopic rail of the drawer door. The thinner cable set allows it to be guided into a drawer door of the household appliance via a telescopic rail by simple and cost-effective means.

The control unit can be designed or designated as a “system master”. It is used in particular to read out the sensor data that is transmitted by the sensor modules that are connected to it and/or to control the sensor modules and has a data processing facility for this purpose, for example a microprocessor, ASIC, FPGA, in particular in the form of what is known as a SoC (“System-on-Chip”).

A sensor module can have one or more sensors. A sensor module is understood to be a stand-alone or replaceable sensor unit or sensor assembly in the electronic architecture of the household appliance. The sensor can be a temperature sensor, brightness sensor, or in particular a camera sensor or gyro sensor or rotation angle sensor.

It is one embodiment that sensor data can be transmitted from the sensor module to the control unit via the FPD-Link III- or GMSL-compliant connection, further data can be transmitted at least from the control unit to the sensor module, and the sensor module can be supplied with electrical power. This makes it possible to achieve particularly simple routing and wiring of the sensor modules. The further data can also be transmitted bidirectionally.

The further data can include control commands, control data and/or general purpose 10 (“GPIO”) data. For example, the control commands can be used to configure and/or trigger a camera sensor, for feedback from a touch screen, etc. In particular, it is thus possible to use the FPD-Link III- or GMSL-compliant connection as a line of a bus system, for example, an I² C bus, since bus control signals can also be transmitted, for example. Accordingly, the FPD-Link III- or GMSL-compliant connection behaves transparently for diverse data interfaces and can serve as a communication path for diverse data interface standards, making the electronic architecture of the household appliance less complex and less expensive.

It is one embodiment that the data processing facility of the control unit has an interface with multiple connections for respective sensor modules, which are connected to a switch and the switch is connected to multiple groups of deserializers, wherein the switch is designed so as to switch between the groups of deserializers alternately, in particular in time-division multiplex. Thus, the advantage is achieved that the number of FPD-Link III- or GMSL-compliant connections that are associated with a control unit can be expanded to virtually any number. In particular, the groups of deserializers can be combined in respective deserializer components. If the number of FPD Link III- or GMSL-compliant connections that can be implemented on a deserializer component is limited, for example to two or four, then, for example, eight FPD Link III- or GMSL-compliant connections or sensor modules can be connected to the control unit for example by means of two deserializer components having four possible FPD Link III- or GMSL-compliant connections each, and twelve FPD Link III- or GMSL-compliant connections in the case of three such deserializer components, and so on.

In general, the household appliance can also have multiple control units for sensor modules, for example a control unit for the refrigeration cycle and ice production unit, which can communicate in particular with one another (for example in a master-slave configuration) and/or with a higher-level central control unit.

The household appliance can have other control units, for example, a control unit for the refrigeration circuit or ice production unit, which are intended to control other functions of the appliance.

It is one embodiment that a data processing facility of the control unit and the sensor modules each have MIPI (“Mobile Industry Processor Interface”) interfaces that are connected to one another by a respective FPD-Link III- or GMSL-compliant connections. MIPI interfaces have the advantage of being cost-effective and designed for very low power consumption. The associated FPD-Link III- or GMSL-compliant connection transparently connects the MIPI interfaces together. If more sensor modules are connected to the control unit than there are MIPI connections on the MIPI interface, in a further development as described above, the MIPI data that is output by the deserializers can be routed to the MIPI interface of the data processing facility or its connections via a switch (then also referred to as an MIPI switch).

It is an embodiment that at least one sensor module is a camera module that comprises a camera sensor. Such a sensor module can also be referred to as a camera module. The camera sensor can be designed, for example, as shown in DE 102013211 098 A1, FIG. 5. The camera sensor can transmit raw data to the control unit via the associated FPD-Link III- or GMSL-compliant link. The control commands that are issued by the control unit to the camera module via the FPD Link III- or GMSL-compliant connection can include, for example, control commands for configuring the camera module and/or trigger commands so as to trigger an image capture of the camera sensor (single image or image sequence/video). Control commands for configuring the camera module can comprise, for example, control commands for configuring the camera sensor (for example, a CCD sensor), a movable optics of the camera module that is associated with the camera sensor, an illumination (for example, an LED) of the camera module, etc.

It is one development that the camera module has a data processing facility for pre-processing the image or sensor data, for example for what is known as de-mosaicing, for color correction, H.264/H.265 encoding and/or distortion correction. Thus, the design that is achieved is a particularly compact and cost-effective design. The data processing facility can be designed as an image preprocessing SoC with integrated MIPI interface.

It is one development that the camera module MIPI/CSI-2 (“Camera Serial Interface 2”) outputs data. This has the advantage that the data transmission is optimized for the transmission of image data.

It is one embodiment that at least one camera module additionally comprises at least one gyro sensor. Thus, a particularly compact and versatile sensor module is provided. The gyro sensor can be used to detect movements, for example, to determine a door opening position, door opening direction and/or door opening speed. The sensor data from the gyro sensor can be used in the control unit, for example, to determine trigger times for a camera sensor of a camera/gyro sensor module integrated into a door. A triggering point is preferably a certain angular position, for example opening position of 45° with respect to the front surface of a body of the household appliance, during the process of closing the door. The control unit can then send appropriate trigger commands, for example, to the sensor module via the FPD-Link III- or GMSL-compliant connection so as to trigger an image capture. Alternatively, the camera/gyro sensor module can trigger or initiate an image capture autonomously. Control commands for configuring the gyro sensor can include reference data for a fully closed state of a door (“zero position”), etc.

A camera/gyro sensor module can be provided on the inside of multiple doors or multi-door household appliances. In particular, the at least two doors close off the same treatment chamber, in particular refrigeration chamber, such as in what are known as “French door” refrigeration appliances. Accordingly, a first camera/gyro sensor module can be provided on a first, left-hand door and a second camera/gyro sensor module can be provided on a second, right-hand door, wherein the first, left-hand door the second, right-hand door close off the same treatment chamber, in particular refrigeration chamber. The first and second camera/gyro module can be connected to the same deserializer accordingly.

Furthermore, the camera/gyro sensor module can be provided on an inside of a drawer door of the household appliance, in particular refrigeration appliance. The door is preferably a drawer door that is guided for linear movement via telescopic rails. The camera/gyro sensor module preferably takes a picture of the contents of the drawer during the process of closing the drawer door.

In one embodiment, the gyro sensor can be used so as to switch the serializer component in the camera module from an inactive state to an active state or vice versa. In particular, this occurs when a movement or change in the angle of rotation of the door is detected by the gyro sensor. The inactive state can be a completely de-energized state or sleep state of the serializer component. The active state is preferably an operational state of the serializer component. The gyro sensor preferably remains in an active state throughout so that movements of the door can always be detected. By having the gyro sensor switch the serializer component in the camera module from the inactive state to the active state, the control unit can communicate with the camera module via the FPD-Link III- or GMSL-compliant connection. Furthermore, when the camera module is not in use, particularly when the door is in the fully closed position, the serializer component can be returned to the inactive state or sleep state. This has the advantage of enabling an energy efficient operation of the household appliance.

Furthermore, the camera module, in particular the camera sensor, can also be placed in the de-energized state or sleep state when not in use. The camera module, in particular the camera sensor, is preferably placed in the inactive state or sleep state by the control unit. This preferably occurs after the door of the household appliance has been completely closed, in particular after a certain waiting time after the door of the household appliance has been completely closed. During the waiting time, the gyro sensor can monitor the movement of the door for a certain period of time, for example 3 to 5 seconds, and both the camera module, in particular the camera sensor, and the serializer/deserializer components remain in the active state, which means that they can react more quickly to a further opening of the door and the start-up or wake-up process of the camera module or the serializer/deserializer components can be omitted.

Alternatively or additionally, a proximity sensor can preferably be provided, which switches the deserializer component of the control unit to the active state. The proximity sensor is preferably arranged on the body of the household appliance or on the door. Preferably, the proximity sensor is a Hall sensor. Preferably, a sensing element, in particular a magnet, is arranged in the door and the sensor unit, in particular the Hall sensor, is provided on the front side of the body of the household appliance. The control unit preferably receives a signal from the proximity sensor that the door, in particular the sensing element, is outside the detection range of the proximity sensor. In that case, the proximity sensor reports this to the control unit and the control unit switches the deserializer component from the inactive state or sleep state to the active state. Furthermore, the control unit can be provided so as to switch the camera module, in particular the camera sensor, to the active state via the FPD-Link III- or GMSL-compliant connection with the serializer and deserializer components already switched to the active state. If the door, in particular the sensing element, is again within the detection range of the proximity sensor, the control unit returns the camera module and then the deserializer to the inactive or sleep state, where appropriate after a certain waiting time of approximately 3 to 5 seconds. The serializer component in the camera module is preferably switched to the inactive state by the gyro sensor. This enables an energy efficient operation of the household appliance.

The camera sensor can be a camera sensor that is sensitive in the visible range and/or in the IR range.

However, other sensors can additionally or alternatively be present in a sensor module, for example a touch screen, a weighing unit, sensors for detecting chemical substances, humidity sensors, temperature sensors, etc.

It is one embodiment that the household appliance is a refrigeration appliance having at least one refrigeration chamber and at least one sensor module is provided for monitoring at least one refrigeration chamber. Thus, by means of a camera module (what is known as a CiF, “camera-in-fridge”), images of the entire refrigeration chamber or of a part thereof (for example of a specific refrigeration tray or compartment) can be captured. Also, a camera module can be used to take a picture of an inside of a door that closes the refrigeration chamber. Possible positions of sensor modules can be provided, in particular, analogously to DE 10 2013 211 098 A1, for example, analogously to DE 10 2013 211 098 A1, FIG. 9. The refrigeration appliance can be a refrigerator, freezer compartment, or any combination thereof.

It is one development that the household appliance is a cooking appliance having at least one cooking compartment and at least one sensor module is provided for monitoring the cooking compartment. Such a sensor module can also be a camera module that can be used, for example, to capture images of food to be cooked, for example, in order to determine a degree of browning.

The object is also achieved by a method for operating a household appliance having at least one sensor module and a control unit, which are connected to one another so as to supply power to the sensor module and to transmit data by a cable set that comprises at least one cable, wherein the at least one sensor module is connected to the control unit via a respective FPD-Link III- or GMSL connection, and wherein in the method:
sensor data that is generated by at least one sensor module is translated into FPD-Link III- or GMSL-compliant serial data by means of a serializer of the FPD-Link III or GMSL connection,
the serial data is transmitted to a deserializer via the cable set,
is retranslated by means of the deserializer, and
the retranslated sensor data is transmitted to the control unit.

The method can be configured analogously to the household appliance, and vice versa, and has the same advantages.

Thus, it is one embodiment that the sensor data from the sensor module is output as MIPI-compliant data.

The above-described characteristics, features and advantages of the present invention, as well as the manner in which they are achieved, will become clearer and more readily understood in connection with the following schematic description of an exemplary embodiment, which will be explained in more detail in connection with the drawings.

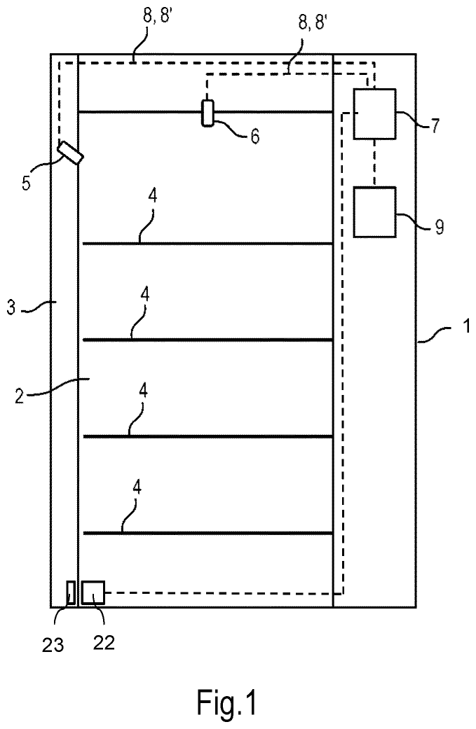

FIG. 1 shows a sectional side view of a household appliance in the form of a refrigerator having multiple sensor modules in the form of camera modules;

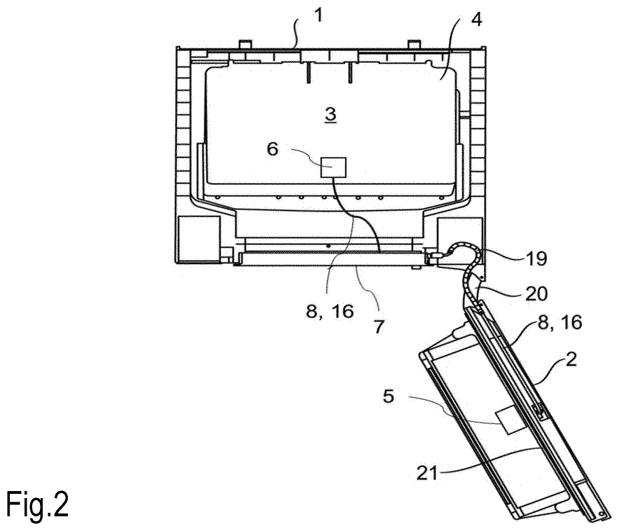

FIG. 2 shows a sectional view of the household appliance according to FIG. 1;

FIG. 2 shows an architecture of a control unit of the refrigerator having a deserializer to which multiple sensor modules are connected via respective FPD-Link III or GMSL-compliant connections; and

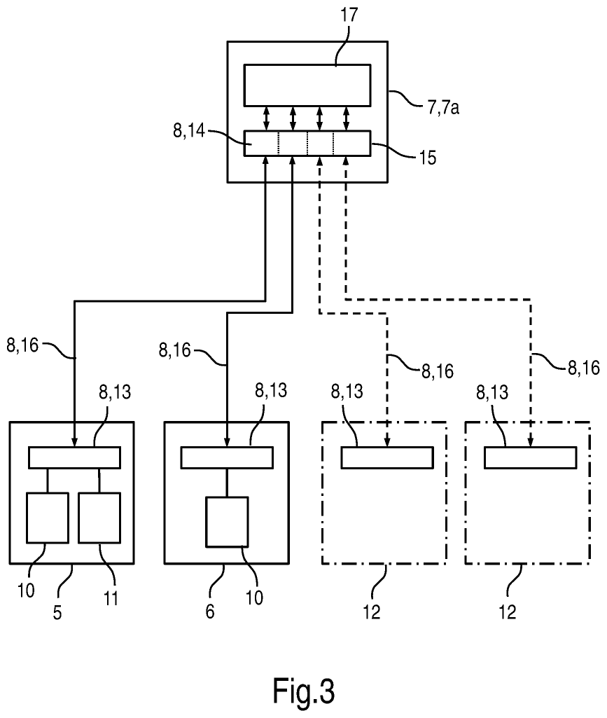

FIG. 3 shows an architecture of a control unit of the refrigerator having multiple deserializers, to each of which multiple sensor modules are connected via respective FPD-Link III- or GMSL-compliant connections.

FIG. 1 shows a sectional side view of a household appliance in the form of a refrigerator 1, which has a refrigeration chamber 3 that can be closed off at the front by means of a door 2. The refrigeration chamber 3 can be subdivided in a fundamentally known manner, for example by glass shelves 4, into multiple sub-chambers or compartments. Also, one or more drawers (not shown) can be provided for receiving refrigerated goods.

Purely by way of example, the refrigerator 1 has two sensor modules in the form of camera modules, namely a camera/gyro module 5 that is accommodated on an inner side 21 of the door 2, and a camera module 6 that is arranged in the region of a ceiling of the refrigeration chamber 3. The camera/gyro module 5 has a camera sensor and at least one gyro sensor, while the camera module 6 has only one camera sensor. The camera/gyro module 5 and the camera module 6 are connected to a control unit (“system master 7”) via a respective FPD-Link III connection 8. Alternatively, the FPD-Link III connection can be implemented as a GMSL-compatible or -compliant connection 8′ (“Gigabit Multimedia Serial Link”).

Furthermore, a proximity sensor 22, in particular a Hall sensor, is arranged on the body of the household appliance 1 and a sensing element 23, in particular magnet, is arranged on the door 2. If the door 2 is in an open position or the sensing element 23 is located outside the detection range of the proximity sensor 22, this is reported by the proximity sensor 22 to the control unit 7, and if the door 2 is in a preferably fully closed position or the sensing element is within the detection range of the proximity sensor 22, the proximity sensor 22 reports this to the control unit 7. Depending on the open position or closed position of the door 2, corresponding electrical units, such as, for example, a serializer/deserializer component or the camera module, can be switched to the active/inactive state or sleep state triggered by the proximity sensor or other sensors in order to enable an energy efficient operation of the household appliance.

The refrigerator 1 can have at least one further control unit, in this case for example a control unit 9 for controlling a refrigeration circuit.

For simplicity, the following explanations are described with reference to the FPD-Link III compliant connection 8, but the explanations apply analogously to the GMSL-compliant connection 8′.

FIG. 2 shows in a sectional view the household appliance according to FIG. 1. In the illustration, the household appliance is also a refrigerator 1. In contrast to FIG. 1, in the illustration the refrigerator 1 is shown with the door 2 in the open position. The door 2 is connected to the refrigerator 1 via a hinge 20, in particular a multi-joint hinge, and the door 2 is pivotable about a vertical axis from a closed position to an open position, and vice versa. Further, a cable set or coaxial cable 16 or FPD-Link III-compliant connection 8 is partially accommodated in a cable chain 19. The cable chain 19 comprises multiple links that are connected to one another in pairs and are pivotable relative to one another about axes that are parallel to one another between a stretched stop configuration and a curved stop configuration. When the door 2 is in the open position, the cable chain 19 tends to be in a more elongated configuration, and when the door 2 is in the closed position, the cable chain 19 tends to be in a more curved or even looped configuration. The cable chain 19 having the cable set 16 is placed on an upper side of the hinge 20 and can further be held on the hinge 20 via fixings. Due to the thin design of the cable set 16, it can be guided via a hinge into the door 2 of the refrigerator 2 by simple and cost-effective means, such as a cable chain 20.

FIG. 3 shows a possible architecture of the system master 7 in a first development 7a, to which multiple sensor modules are connected via respective FPD-Link III-compliant connections 8, and namely here the camera/gyro sensor module 5 that is equipped with a camera sensor 10 and at least one gyro sensor 11, the camera module 6 that is equipped with a camera sensor 10, and where appropriate two further sensor modules 12 via respective FPD-Link III-compliant connections 8 (shown in dashed lines).

The FPD-Link III connections 8 each comprise a serializer 13, which is integrated in the sensor modules 5, 6 and 12, and a deserializer 14 which is integrated in the system master 7a, wherein four deserializers 14 are accommodated in a common deserializer component 15. The serializers 13 are connected to one another with the respective deserializers 14 via respective FPD-Link III-compliant coaxial cables 16 of the respective FPD-Link III connections 8.

The deserializers 12 are connected to a respective connection of, here by way of example, a total of four connections of an MIPI interface of a data processing facility 17 of the system master 7a, so that the respective sensors of the sensor modules 5, 6 and 12, which also have MIPI interfaces, are transparently connected to the respective connections of the MIPI interface of the data processing facility 17. Camera modules 5, 6, 12 that are equipped with a camera sensor 10 can also still have image pre-processing.

Sensor data (i.e. image data) that is recorded by the camera sensors 10 is output as—where appropriate pre-processed—MIPI-compliant data to the associated serializer 13, which transforms the MIPI data in an FPD-Link III-compliant manner and sends it to the associated deserializer 14 via the respective coaxial cable 16. At the deserializer 14, the serialized data is retransformed into the original MIPI data and forwarded to the MIPI interface of the data processing facility 17. The data processing facility 17 can further process and evaluate the images, for example, so as to detect objects that are stored in the refrigeration chamber 3, etc.

In the reverse direction, the data processing facility 17 can, for example, send control data specifically to the sensor modules 5, 6 and 12.

Sensor data from sensors other than the camera sensors 10, such as the gyro sensor 11, are transmitted analogously and can be transmitted via the same FPD-Link III-compliant connection 8 and received logically separately by the data processing facility 17, in particular when a bus architecture is used, for example an I²C bus. Thus, the FPD-Link III-compliant connection 8 can also be used generally as a bus line.

Further, the gyro sensor 15 can be provided so as to switch the serializer 13 from an active to an inactive state, for example completely de-energized or asleep, or vice versa, in order to enable an energy efficient operation of the household appliance 1. The camera sensor 10 can likewise be switched to an inactive state, for example fully de-energized or asleep, by the control unit 7, that is triggered by the proximity sensor 22 or gyro sensor 11, via the active FPD-Link III-compliant connection 8, for energy efficiency reasons.

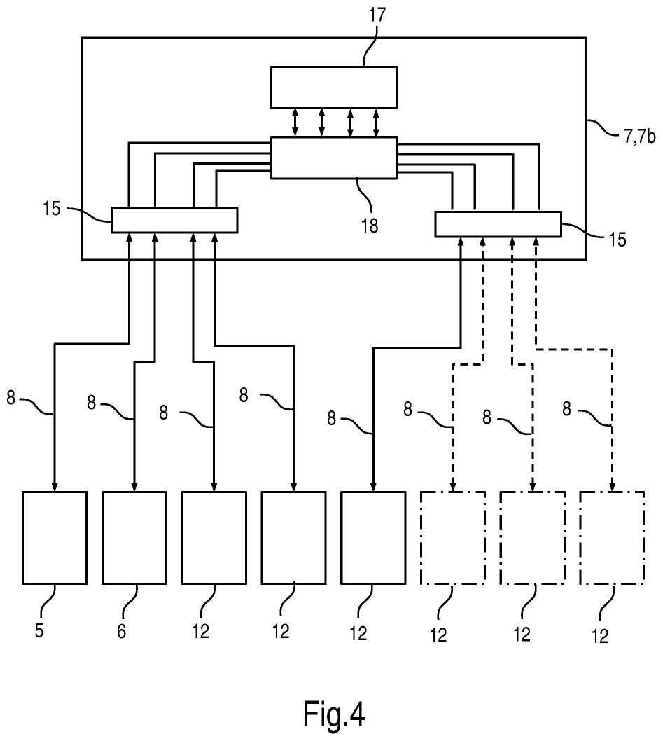

FIG. 4 shows an architecture with an alternative development 7b of the system master 7, to which more sensor modules are connected via respective FPD-Link III-compliant connections 8 to the system master 7b than MIPI connections are available at the data processing facility 17, and namely in this case the camera module 5, the camera module 6, three further sensor modules 12 and where appropriate still further sensor modules 12 (shown in dashed lines).

Since the deserializer components 15 here have only four connections for coaxial cables 16, two deserializer components 15 are used so as to connect up to eight sensor modules 5, 6, 12, and via a switch said deserializer components run here: an MIPI switch 18, so that the MIPI data that is output by the deserializers 14 arrives at the data processing facility 17 alternately, for example time-multiplexed. This setup circumvents a possible limitation in the number of connections of the deserializer components 15. The system master 7b can therefore also be used to implement, for example, a 6-5 or 8-camera module concept. This setup can be extended in analogy to more than eight sensor modules 5, 6, 12 as desired.

Of course, the present invention is not limited to the exemplary embodiment shown.

Thus, there can also be more or fewer MIPI connections on the data processing facility 17. In addition, multiple deserializers 14 need not be combined into one deserializer component 15. Further, said deserializer component 15 can also have more or fewer deserializers 14 than there are MIPI connections on data processing facility 17.

In general, “a”, “one”, etc. can be understood to be singular or plural, especially in the sense of “at least one” or “one or more”, etc., as long as this is not explicitly excluded, for example by the expression “precisely one”, etc.

Also, a numerical specification can include exactly the specified number as well as a usual tolerance range, as long as this is not explicitly excluded.

### LIST OF REFERENCE CHARACTERS

1 Refrigerator
2 Door
3 Refrigeration chamber
4 Shelf
5 Camera/gyro module
6 Camera module
7 System master
7a First variant of the system master
7b Second variant of the system master
8 FPD-Link III connection
8′ GMSL connection
9 Control unit for controlling a refrigeration circuit
10 Camera sensor
11 Gyro sensor
12 Further sensor module
13 Serializer
14 Deserializer
15 Deserializer component
16 Coaxial cable
17 Data processing facility
18 MIPI switch
19 Cable chain
20 Hinge
21 Inside
22 Proximity sensor
23 Sensing element

1-12. (canceled)

13. A household appliance, comprising:
at least one sensor module;
a controller;
a cable set, said controller connected to said at least one sensor module by said cable set, said cable set having at least one cable so as to supply power to said at least one sensor module and to transmit data; and
a connection selected from the group consisting of: a flat panel display (FPD)-Link III-complaint connection and a gigabit multimedia serial link (GMSL)-compliant connection, wherein said at least one sensor module is connected to said controller via said FPD-Link III-complaint connection or said GMSL-compliant connection, said connection containing a serializer being associated with said at least one sensor module and a deserializer being associated with said controller, said cable set connecting said serializer and said deserializer.

14. The household appliance according to claim 13, wherein said cable set has a single coaxial cable.

15. The household appliance according to claim 13, wherein said cable set contains a twisted pair cable and at least one further cable so as to supply the power to said at least one sensor module.

16. The household appliance according to claim 13, wherein said serializer of said FPD-Link III-compliant connection or said GMSL-compliant connection is integrated into said at least one sensor module and said deserializer is integrated into said controller.

17. The household appliance according to claim 13, wherein via said FPD-Link III-complaint connection or said GMSL-compliant connection:
sensor data is transmitted from said at least one sensor module to said controller;
further data is transmitted at least from said controller to said at least one sensor module; and
said at least one sensor module is supplied with electrical energy.

18. The household appliance according to claim 13, wherein:
said at least one sensor is one of a plurality of sensors; and
said controller contains a switch and a data processing facility having an interface with multiple connections for said sensor modules which are connected to said switch and said switch is connected to multiple groups of said deserializer, wherein said switch is configured so as to switch alternately between said multiple groups of said deserializer.

19. The household appliance according to claim 13, wherein:
said at least one sensor is one of a plurality of sensors; and
said controller has a data processing facility, said data processing facility and said sensor modules each have a mobile industry processor interface (MIPI) that are connected to one another by a respective one said FPD-Link III-compliant connection or said GMSL-compliant connection.

20. The household appliance according to claim 13, wherein said at least one sensor module is a camera module that has a camera sensor.

21. The household appliance according to claim 20, wherein said camera module has additionally at least one gyro sensor.

22. The household appliance according to claim 13, wherein the household appliance is a refrigeration appliance having at least one refrigeration chamber and said at least one sensor module is provided so as to monitor said at least one refrigeration chamber.

23. A method for operating a household appliance having at least one sensor module and a controller, which are connected to one another so as to supply power to the at least one sensor module and to transmit data by a cable set that contains at least one cable, wherein the at least one sensor module is connected to the controller via a flat panel display (FPD)-Link III-complaint connection or a gigabit multimedia serial link (GMSL)-compliant connection, which comprises the step of:
translating sensor data being generated by the at least one sensor module into FPD-Link III-compliant serial data or GMSL-compliant serial data by means of a serializer of the FPD-Link III-compliant connection or the GMSL compliant connection;
transmitting the FPD-Link III-compliant serial data or the GMSL-compliant serial data via the cable set to a deserializer;
retranslating the FPD-Link III-compliant serial data or the GMSL-compliant serial data by means of the deserializer resulting in retranslated sensor data; and
transmitting the retranslated sensor data to the controller.

24. The method according to claim 23, wherein the sensor data is present as mobile industry processor interface compliant data.
